(19) United States
(12) Patent Application Publication
(10) Pub. No.: US 2025/0353487 A1
(43) Pub. Date: Nov. 20, 2025

(54) HYBRID HAUL TRUCK ROUTE OPTIMIZATION BASED ON BATTERY CHARGE

(71) Applicant: FLANDERS ELECTRIC MOTOR SERVICE, LLC, Evansville, IN (US)

(72) Inventors: Wayne CHMIEL, Evansville, IN (US); Brian Curtis HAVENS, Columbia, SC (US)

(73) Assignee: FLANDERS ELECTRIC MOTOR SERVICE, LLC, Evansville, IN (US)

(21) Appl. No.: 19/204,391

(22) Filed: May 9, 2025

Related U.S. Application Data
(60) Provisional application No. 63/649,935, filed on May 20, 2024.

(51) Int. Cl. B60W 20/15; B60K 6/28; B60K 6/40; B60K 6/52; B60L 53/14; B60L 55/00; B60W 10/08; B60W 20/12; B60W 30/182; B60W 40/12; G07C 5/02; H02S 20/30

(52) U.S. Cl. CPC B60W 20/15; B60K 6/28; B60K 6/40; B60K 6/52; B60L 53/14; B60L 55/00; B60W 10/08; B60W 20/12; B60W 30/182; B60W 40/12; G07C 5/02; H02S 20/30; B60W 2300/125; B60W 2300/18; B60W 2510/244; B60W 2556/45; B60W 2710/244; B60Y 2200/92

(57) ABSTRACT

A vehicle including a chassis and an engine connected to the chassis. The vehicle also includes an alternator connected to the engine and a drive system connected to the alternator. The vehicle also includes a number of wheel motors connected to the drive system and a number of wheels connected to the number of wheel motors. The vehicle also includes a battery connected to the number of wheel motors and to the alternator. The vehicle also includes a computer processor connected via a number of sensors to the engine, the alternator, the drive system, the number of wheel motors, the number of wheels, the battery, and to a data repository storing a routing plan for a number of vehicles including the vehicle. The computer processor is programmed to assign, according to a current charge in the battery, the vehicle to a route on the routing plan.

### RELATED APPLICATIONS

This application claims priority to U.S. Provisional Patent Application No. 63/649,935, filed May 20, 2024, the entirety of which is hereby incorporated by reference.

### BACKGROUND

A haul truck is a large vehicle (relative to standard freight haul trucks found on public roadways) used to haul dirt and other materials during large scale excavation projects. Hybrid haul trucks incorporate one or more batteries as part of the drive system of the haul truck. Managing the battery charge of the one or more batteries is part of managing the hybrid haul truck.

Hybrid haul trucks are more fuel efficient than haul trucks powered only by internal combustion engines. A hybrid haul truck powers a drive system with a combination of an internal combustion engine, electric wheel motors, and one or more batteries. The electric wheel motors may be used to propel the truck, or when the truck is moving downhill, the electric motors may be used to recharge the batteries. Thus, hybrid haul trucks use less fuel than haul trucks powered only by internal combustion engines.

However, hybrid haul trucks still may consume thousands of gallons of fuel per year of operation, with attendant fuel costs and production of emissions and greenhouse gasses. Thus, a technical problem exists with respect to operating hybrid haul trucks. The technical problem is how to minimize fuel consumption by hybrid haul trucks.

### SUMMARY

One or more embodiments provide for a vehicle. The vehicle includes a chassis and an engine connected to the chassis. The vehicle also includes an alternator connected to the engine. The vehicle also includes a drive system connected to the alternator. The vehicle also includes a number of wheel motors connected to the drive system. The vehicle also includes a number of wheels connected to the number of wheel motors. The vehicle also includes a battery connected to the number of wheel motors and to the alternator. The vehicle also includes a computer processor connected via a number of sensors to the engine, the alternator, the drive system, the number of wheel motors, the number of wheels, the battery, and to a data repository storing a routing plan for a number of vehicles including the vehicle. The computer processor is programmed to assign, according to a current charge in the battery, the vehicle to a route on the routing plan.

One or more embodiments also provide for a system. The system includes a number of vehicles. Each of the number of vehicles includes a chassis and an engine connected to the chassis. The number of vehicles also each include an alternator connected to the engine. The number of vehicles also each include a drive system connected to the alternator. The number of vehicles also each include a number of wheel motors connected to the drive system. The number of vehicles also each include a number of wheels connected to the number of wheel motors. The number of vehicles also each include a battery connected to the number of wheel motors and to the alternator, the battery having a respective maximum charge. The number of vehicles also each include a computer processor connected via a number of sensors to the engine, the alternator, the drive system, the number of wheel motors, the number of wheels, and the battery. The system also includes a central dispatch system programmed to assign the number of vehicles to a number of routes on a routing plan, within a constraint of the respective maximum charge in the battery of each of the number of vehicles, to maximize an overall amount of electrical charge generated by the number of vehicles while operating the number of vehicles on the number of routes.

One or more embodiments also provide a method. The method includes measuring an initial charge in a battery of a vehicle including a wheel and a wheel motor connected to the wheel and to the battery. The method also includes predicting, by a computer processor, a number of expected increases in a charge of the battery, a number of expected decreases in the charge of the battery, or a combination thereof, while operating the vehicle over a number of routes in a routing plan. The method also includes selecting a selected route from among the number of routes according to at least one of: the initial charge, a maximum net increase in the charge on the selected route relative to other routes on the number of routes, a minimum decrease in the charge on the selected route relative to the other routes, or maintaining the charge on the selected route relative to the other routes. The method also includes operating the vehicle on the selected route before operating the vehicle on the other routes.

Other aspects of the one or more embodiments will be apparent from the following description and the appended claims.

### BRIEF DESCRIPTION OF DRAWINGS

FIG. 1 shows an example of a haul truck, in accordance with one or more embodiments.

FIG. 2 shows a block diagram of a haul truck modified into a hybrid haul truck, in accordance with one or more embodiments.

FIG. 3 shows an example of a diesel engine fuel map, in accordance with one or more embodiments.

FIG. 4 shows an example of a haul truck route that results in less charge in the battery of the haul truck, in accordance with one or more embodiments.

FIG. 5 shows a haul truck route that results in more charge in the battery of the haul truck, in accordance with one or more embodiments.

FIG. 6 and FIG. 7 show methods for hybrid haul truck route optimization based on battery charge, in accordance with one or more embodiments.

FIG. 8 shows a method of operating a vehicle, in accordance with one or more embodiments.

FIG. 9A and FIG. 9B show a computing system and network environment which may be used to implement the method of FIG. 6, FIG. 7, and FIG. 8, in accordance with one or more embodiments.

Like elements in the various figures are denoted by like reference numerals for consistency.

### DETAILED DESCRIPTION

One or more embodiments are directed to a technical solution to the technical problem of how to minimize fuel consumption by hybrid haul trucks. The technical solution involves the automated determination of the routes that one or more haul trucks take during industrial operations. The routes are determined so that the maximum amount of electrical energy is generated and used during the industrial operations. In general, the routes are determined so that haul trucks with more fully charged batteries take more uphill paths, and haul trucks with more depleted batteries take more downhill paths. In this manner, electricity generated by the wheel motors is not wasted when the battery is more fully charged during downhill routes. Additionally, the internal combustion engine is engaged less frequently when driving uphill because more electrical energy is available in the batteries. Thus, the amount of electrical energy generated by the wheel motors that is used to propel the haul trucks is maximized, and the amount of energy generated by the internal combustion engine is minimized. As a result, substantial fuel savings may be achieved.

In more detail, haul trucks may operate continuously over a set of routes, with certain haul trucks assigned to certain routes. The haul trucks may operate over the same route multiple times in a loop. Hybrid haul trucks use the downhill portion of the route to charge the battery using kinetic energy. If a route has a downhill section that results in more charge in the battery at the end of the route than what the haul truck had when it started the route, eventually the battery will be filled and the energy from operating downhill will be wasted. In comparison, if a route results in less charge in the battery at the end than what was available at the start of the route, then the battery will be fully discharged and not able to offer fuel saving benefits.

Thus, as also explained above, one or more embodiments are directed to methods and devices for assigning haul trucks to routes based on battery charge levels of batteries on the haul trucks. Haul trucks with lower battery levels are transferred to routes that result in a net gain in battery charge. Haul trucks with higher battery levels are transferred to routes that result in a net loss in battery charge. The route optimization may be used to maximize the use of energy gained operating downhill and reduce engine power used to charge the battery. Thus, one or more embodiments may save fuel, hence saving money as well as reducing the carbon footprint of operating a haul truck.

One or more embodiments contemplate that the total battery level used to complete a route may be tracked to prevent a haul truck with a battery level that is too low from attempting a route that requires more battery capacity than the haul truck has available. If a haul truck is to complete a route that requires more battery capacity than is currently available, then the truck may be placed in an idle state in which the engine is running and the battery is being charged. Idle time, such as when the haul truck is loaded or is waiting in a queue, can be used to charge the battery to the desired capacity.

While one or more embodiments are described with respect to haul trucks, one or more embodiments may include other types of vehicles that use a motor, engine, and a rechargeable battery. Thus, while the term “haul truck” is used herein, one or more embodiments described herein may be applied to hybrid freight trucks, to hybrid automobiles, such as consumer trucks and sedans, to hybrid boats, to hybrid aircraft, etc. Accordingly, the term “haul truck” automatically contemplates other types of hybrid vehicles which use a combination of an internal combustion engine, a motor, and a battery to power the drive system of the vehicle.

Additionally, one or more embodiments may refer to the “the battery.” The term “the battery” automatically contemplates one or more batteries, whether located separately or together on a haul truck.

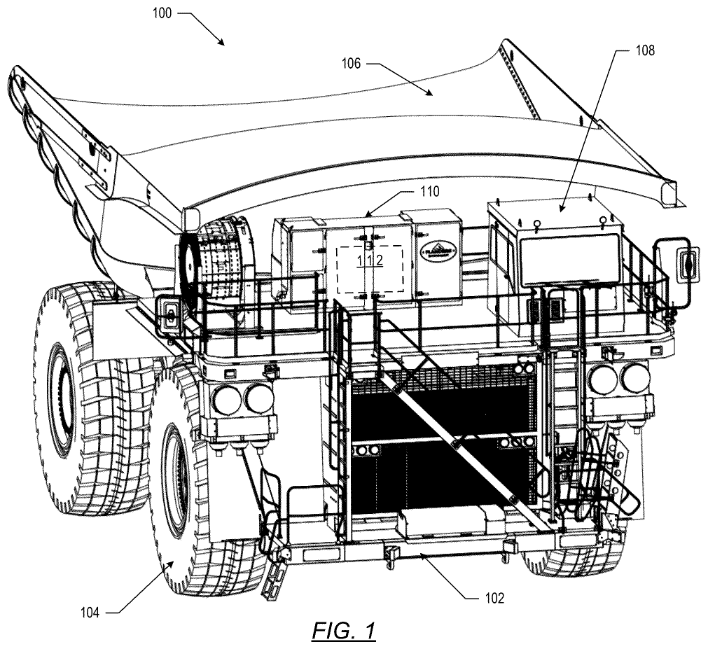

Attention is now turned to the figures. FIG. 1 shows an example of a haul truck, in accordance with one or more embodiments. The haul truck (100) includes a chassis (102). The chassis (102) is connected to the wheels, such as wheel (104). Note that the chassis (102) may include many structural components of the haul truck (100), not just the single component as the arrow indicates for the chassis (102) in FIG. 1.

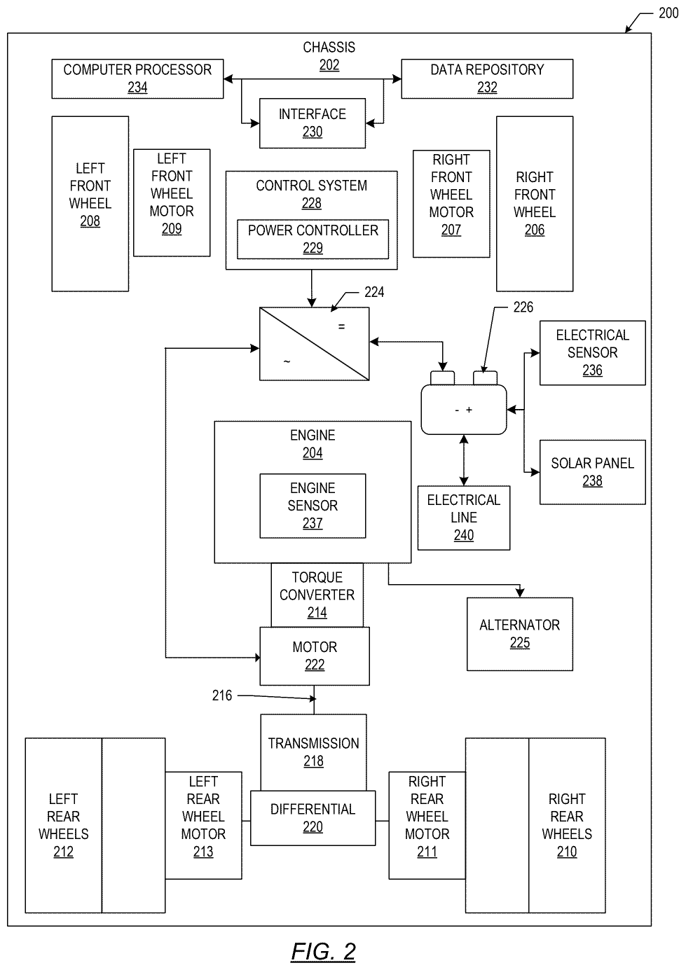

The haul truck (100) also includes a bed (106) used for hauling loads. The haul truck (100) may include a cabin (108) where a human operator may operate the haul truck (100). The haul truck (100) further includes a drive system (110) with control modules and electronics. The drive system (110) includes a battery (112) shown in dashed lines within the cabinet in which the drive system (110) is held. The battery (112) may be stored in various different locations on and within the haul truck (100). As defined above, the battery (112) automatically contemplates two or more batteries that, either separately or together, are connected to one or more of the wheel motors and possibly other electrical components of the haul truck (100) (see FIG. 2).

While FIG. 1 shows a configuration of components, other configurations may be used without departing from the scope of one or more embodiments. For example, various components may be combined to create a single component. As another example, the functionality performed by a single component may be performed by two or more components. More or fewer components may be present on the haul truck (100).

FIG. 2 shows a block diagram of a haul truck modified into a hybrid haul truck, in accordance with one or more embodiments. The haul truck (200) may be a block representation of the haul truck (100) shown in FIG. 1.

The haul truck (200) includes a chassis (202) which forms a frame for the haul truck (200). Thus, the chassis (202) may include many different components connected directly or indirectly to each other, including panels, cross-beams, grills, connectors, etc.

The haul truck (200) also includes an engine (204) connected to the chassis (202). The engine (204) may be one or more internal combustion engines, such as one or more diesel engines, gasoline engines, etc. The engine (204) also may be replaced with fuel cells or other alternative energy sources.

The haul truck (200) also includes wheels connected to the chassis (202). The wheels are also indirectly connected to the engine (204) via the motor (222) and other intervening components. Haul trucks generally include four or more wheels. In the example of FIG. 2, the haul truck (200) includes right front wheel (206), left front wheel (208), right rear wheels (210) (two wheels operating in tandem), and left rear wheels (212) (two wheels operating in tandem).

Each of the wheels may be connected to a wheel motor. Thus, the right front wheel (206) is connected to a right front wheel motor (207), the left front wheel (208) may be connected to a left front wheel motor (209), the right rear wheels (210) may be connected to one or more right rear wheel motors (211), and the left rear wheels (212) may be connected to one or more left rear wheel motors (213). Each of the wheel motors are electric motors. During use, the battery (226) may supply electrical power to the wheel motors in order to drive the truck. However, when the haul truck (200) is braking or moving downhill, then the wheel motors may be engaged in an opposite direction such that the wheels drive the wheel motors. In this case, the wheel motors generate electricity, which in turn may be stored in the battery (226).

The haul truck (200) also includes a torque converter (214). The torque converter (214) is a device, usually implemented as a type of fluid coupling, that transfers rotating power from a prime mover, like the internal combustion engine (204), to a rotating driven load. In unmodified haul trucks, the torque converter (214) is connected directly to the drive shaft (216). However, as explained below, in one or more embodiments the drive shaft (216) is directly connected to the torque converter (214) or to the engine (204) on the side of the engine (204) on which the torque converter (214) is connected.

The drive shaft (216) is connected to a transmission (218). The transmission (218) is a set of gears and other components that transforms the speed or direction of a machine. The transmission (218) may adjust the gear ratio between the engine and differential (220) (see below) so that engine stays in a narrow speed range regardless of the final vehicle speed.

The transmission (218) is connected to a differential (220). The differential (220) is a set of gears and other components that transmits rotational energy from the transmission (218) to the wheels. The differential (220) may allow the wheels to rotate at different speeds on turns. For example, the drive shaft (216) may rotate about an axis parallel to a length of the drive shaft (216). The differential changes the rotational direction of the drive shaft (216) into a rotational direction perpendicular to the length of the drive shaft (216). In this manner, the direction of rotation in the differential (220) may be perpendicular to the length of the drive shaft (216).

The haul truck (200) also includes a motor (222), which may be installed in the haul truck (200) during a retrofit process, as explained below. The motor (222) is directly connected to the torque converter (214) or to the engine (204) on the side of the engine (204) to which the torque converter (214) is connected. The motor (222) is then connected to the drive shaft (216), which in turn connects to the transmission (218), the differential (220), and the rear wheels. Position of the motor (222) may vary, as described further below.

A useful design aspect of the placement of the motor (222) is that the motor is secured during high impact and high vibration operations while the haul truck (200) is in use. Furthermore, the motor (222) fits within an existing space near the torque converter (214), and accordingly may be sized and dimensioned to be approximately equal to or less than the corresponding dimensions of the engine (204). The motor (222) is designed for use with the haul truck (200), and in particular is designed to be installed into an existing haul truck with a combustion engine drive system. An existing haul truck may have an engine directly connected to a drive shaft, which is directly connected to a transmission, which is directly connected to a differential, which is directly connected to the wheels.

The motor (222) may be an alternating current (AC) motor that provides a minimum of 400 kilowatts (KW) of continuous electrical energy. The motor (222) may also provide 800 kW at peak power at a rotational speed of 1,800 revolutions per minute (RPM) to reach desired fuel savings.

In addition, the motor (222) may be sealed to prevent the ingress of liquid, dust, and other contaminants. The undercarriage of a haul truck is a dirty environment with mud, rocks, and debris thrown up and stuck to the surfaces of the undercarriage. Thus, sealing features may be provided to prevent debris from entering the internal parts of the motor (222).

The motor (222) is connected to an inverter (224). The inverter (224) is an electronic device or circuitry that changes a direct current (DC) to alternating current (AC). The AC current may be a form of electrical current that is used to control the speed and torque of the motor (222).

The inverter (224) may operate in a voltage range from under 1,000 volts (V) to over 2,600 V and current from under 1,000 amps (A) to over 4,000 A. The inverter (224) may be used with different engines, traction motors, and alternators (e.g., alternator (225)) while also fitting in the space available on the deck of the haul truck (200).

The alternator (225) is a type of electric generator to charge the battery (112) and to power an electrical system of the haul truck (200) when the engine (204) is running. Note that in a hybrid haul truck, the alternator (225) may be replaced with one or more combined motors and generators that start the engine (204), provide some or all of the mechanical power to the wheels via wheel motors, and charge the battery (112).

Returning to the inverter (224), the inverter (224) may include a cluster of four (or more or fewer) liquid cooled power electronic devices. Three devices may be used as phase legs of the inverter (224) and the fourth device may be used as a braking chopper or DC/DC converter. This cluster may be supported by a laminated AC and DC bus design that allows stacking multiple clusters together to form a system.

The clusters may be combined in parallel to increase the total maximum current with each set of parallel clusters. The clusters also may be combined in a series to increase the total maximum voltage with each set of series clusters. Such an arrangement allows for compatibility with different motors and alternators that are designed for different voltages and currents. Thus, for example, the inverter (224) may be customized to match an old haul truck's engineering specifications, and potentially multiple generations of engineering specifications of many different haul trucks.

The inverter (224) may be composed of multiple inverters in the form of inverter clusters. Each inverter cluster may be isolated from another inverter cluster to allow each inverter cluster to operate independently in the event one or more of the inverters fail to function within predetermined engineering specifications. This arrangement allows a diesel-electric haul truck to still move slow in the event of an inverter or the motor failing to function within predetermined engineering specifications.

The isolation may extend beyond the inverter (224). The DC/DC clusters may be isolated from each other to allow the power system to completely disconnect form power sources that could be operating outside predetermined engineering tolerances.

The inverter (224) may be connected to a battery (226). The battery (226) is one or more batteries that store or discharge electrical energy via the inverter (224). For example, dual batteries can be utilized. Each of the dual batteries may be connected to an isolated DC/DC converter and the inverter (224), thereby providing for an independent power system.

The battery (226) may be charged using the engine (204) (by utilizing regenerative braking), by a fast charger, a small separately powered generator (known as a range extender), or by another compatible haul truck system. The battery (226) also may be used to power other systems on the haul truck (200) to allow the haul truck (200) to operate without the engine (204) running.

The inverter (224) is connected to a control system (228). The control system (228) is electrical and mechanical components that control the distribution of electrical power to other electrical components of the haul truck (200), and also may control operational aspects of the haul truck (200) (e.g., speed, gear ratios, etc.). For example, the control system (228) may control the amount of power generated by or used by the motor (222), and thus may control the amount of power applied to the drive shaft (216) via the motor (222). The control system (228) also may control electrical power to other electrical components in the haul truck (200), such as the battery (226), or various other electrical systems.

The control system (228) may be based on a programmable logic controller hardware platform or embedded system. The platform may be used to control and monitor various functions and systems of the haul truck (200). Integrated security may be used to protect against unintended modification while still allowing flexibility in customization depending on customer specifications.

The control system (228) may include a variety of components. The control system (228) may include the programmable logic controller, an embedded computer (e.g., the computer processor (234), communications modules and equipment, power supplies and power distribution equipment, diagnostics and data logging computing devices, radio equipment, etc.

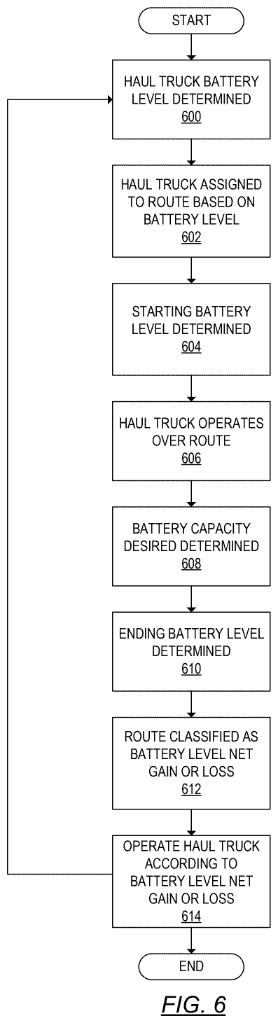

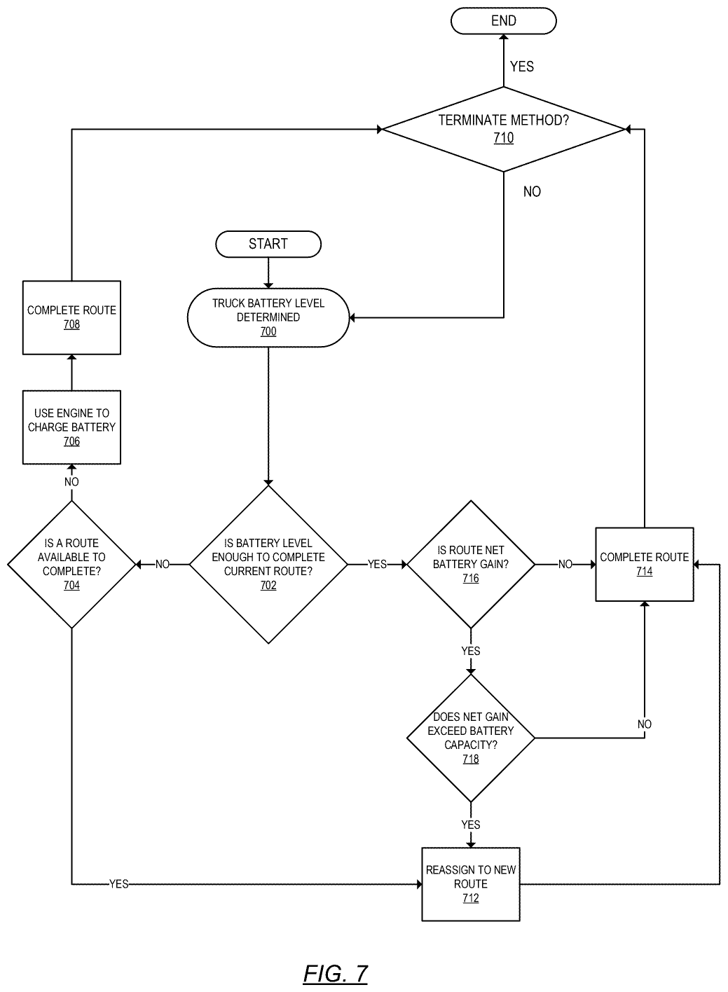

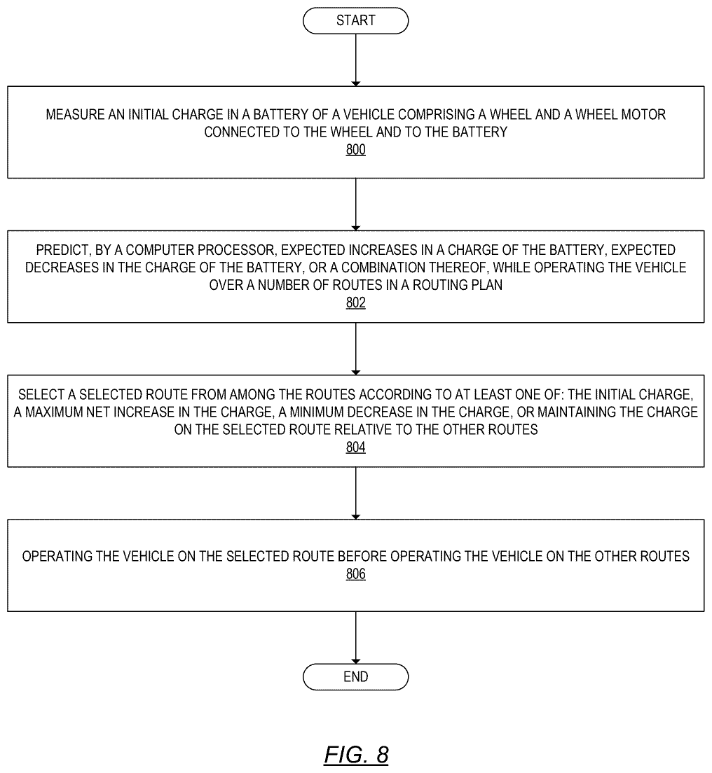

The control system (228) also may include an algorithm, a machine learning model, or application specific integrated circuit that is programmed to execute the methods of FIG. 6, FIG. 7, or FIG. 8. Thus, in one embodiment, the control system (228) may be characterized as a computer processor connected via a number of sensors (see below) to the engine (204), the alternator (225), the drive system (110), the wheel motors (see below), the wheels (e.g., right front wheel (206) or the other wheels), the battery (112), and to a data repository (232) (see below).

Thus, as indicated above, the control system (228) is connected, at least indirectly, to the battery (226), the engine (204), and the wheel motors (207, 209, 211, 213). The control system (228) may be configured to modify operation of each of the engine (204), the wheel motors (207, 209, 211, 213), and the battery (226) according to the route, as described with respect to FIG. 6 through FIG. 8.

The control system (228) may include a power controller (229). The power controller (229) is electrical equipment connected to the control system that is configured to control distribution of electrical power to the wheel motors (207, 209, 211, 213) and the battery (226). In an embodiment, the power controller (229) may include the inverter (224).

In an embodiment, the power controller (229) may control a speed of operation of the haul truck (200) on the route to either minimize a first amount of energy drained from the battery over a course of the route or to maximize a second amount of energy added to the battery over the course the route. Operation of the power controller in this regard is performed according to the method of FIG. 6 through FIG. 8 by issuing a command to the control system (228) to operate the haul truck (200) accordingly.

The haul truck (200) also includes an interface (230), which may be connected (at least indirectly) to the control system (228). The interface (230) includes a display (monitor, touchscreen, audio device, haptic device, etc.) for displaying information to a user. The interface (230) also includes one or more user devices (touchscreens, speakers, haptic devices, mice, keyboards, etc.) so that an operator may control various functions of the control system (228).

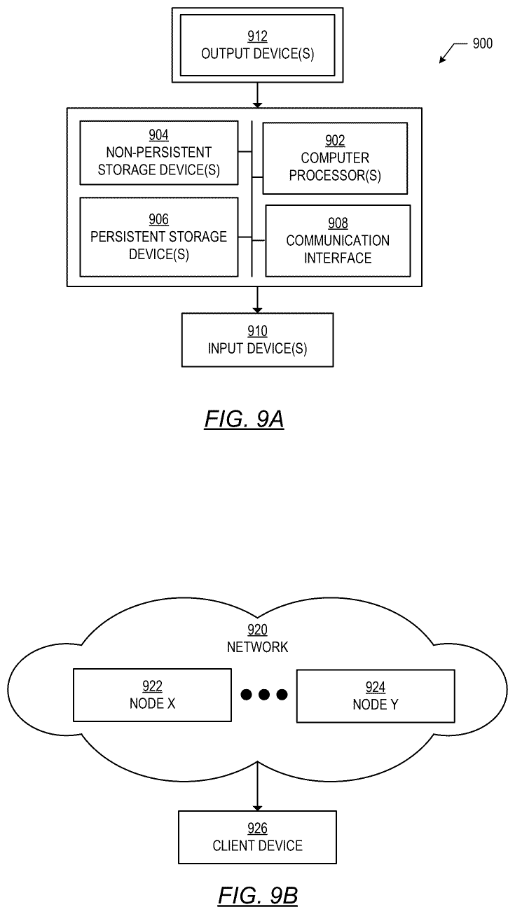

The haul truck (200) also includes a data repository (232). The data repository (232) may be the persistent storage device(s) (906) of FIG. 9. However, the data repository (232) may be located remotely from the haul truck (200), in which case the data repository (232) is in electronic communication (wireless or wired) with the interface (230) or a computer processor (234) aboard the haul truck (200). The data repository (232) stores a routing plan for the vehicle (or for two or more vehicles including the haul truck (200)). The computer processor (which may be the same processor that operates the interface (230)) is programmed to assign, according to a current charge in the battery, the vehicle to a route on the routing plan.

The haul truck (200) includes a computer processor (234) located onboard the haul truck (200). The computer processor (234) may be the computer processor(s) (902) of FIG. 2. The computer processor (234) may execute the methods of FIG. 6, FIG. 7, or FIG. 8.

The computer processor (234) is in electronic communication with the control system (228). Thus, the computer processor (234) may be programmed to control operation of at least one of the battery (226), the engine (204), and the wheel motors (207, 209, 211, 213) via the control system (228), as described with respect to FIG. 6 through FIG. 8.

In an embodiment, the computer processor (234) may be programmed to estimate a ratio of fuel savings by the haul truck (200) relative to a performance increase by the haul truck (200). For example, a machine learning model or a non-learning computer algorithm may predict how increasing or decreasing performance increases or decreases the amount of fuel used to perform vehicle operations on a selected route. The computer processor (234) also may be programmed to order the control system (228) to modify operation of the haul truck (200) on the route to increase the fuel savings or improve the performance increase based on the ratio.

Yet further, the computer processor (234) may be further programmed to determine a health of the vehicle based on an unplanned change to the ratio while the vehicle operates on the route. For example, if the ratio of fuel savings to performance decreases, then one or more components of the haul truck (200) may exhibit a degraded performance. Maintenance performed on the one or more components (e.g., cleaning a motor, replacing a part, lubricating one or more moving parts, etc.) may raise the ratio back to an expected value.

In still another embodiment, the computer processor (234) may be programmed, after the haul truck (200) completes the route, to reassign the haul truck (200) to a second route in the route plan to maximize an amount of energy generated by the wheel motors (207, 209, 211, 213) during operation of the wheel motors (207, 209, 211, 213) over a combination of the route and the second route. Thus, the computer processor (234) may change the route taken by the haul truck (200) in mid route.

The computer processor (234) may be connected via a number of sensors (see below) to the engine (204), the alternator (225), the drive system (110), the wheel motors (see below), the wheels (e.g., right front wheel (206) or the other wheels), the battery (112), and to the data repository (232). Note that the computer processor (234) also may be connected directly to the various components of the haul truck (200) in order to control the operation of said components.

The sensors may include an electrical sensor (236). The electrical sensor (236) is one or more electrical sensors that may sense voltage, current, battery charge level, or other electrical properties. The electrical sensor (236) may be connected to the battery (226), the computer processor (234), or to other components, such as the alternator (225), the interface (230), the data repository (232), one or more wheel motors, or other components that have electrical properties of interest.

The sensors also may include an engine sensor (237). The engine sensor (237) is one or more sensors that sense parameters of the engine operation, including fuel consumption, revolutions per minute, torque generated, etc.

The sensors also may include a global positioning system (GPS) sensor, together with a GPS transmitter that forms a GPS system. The GPS system may communicate with the global GPS satellites in order to determine a position of the haul truck (200) on the Earth, and within a specific location at a mining site. The position may be stored in the data repository (232) as part of the data used to determine routes for the haul truck according to the methods described herein, such as the method of FIG. 8. The sensors also may include a fuel gage, a speedometer, odometer, and other sensors useful for planning the route of the haul truck (200), as explained with respect to the methods described herein, such as the method of FIG. 8.

The haul truck (200) may be provided with additional components. For example, the haul truck (200) may include a solar panel (238) connected to the chassis (202). The solar panel (238) is in electrical communication with the battery (226). The solar panel (238) may generate additional electrical energy for storage in the battery and used by the wheel motors (207, 209, 211, 213). Furthermore, the computer processor (234) may be programmed to assign the haul truck (200) to the route according to a predicted amount of electrical energy generated by the solar panel. In other words, the route planning may take into account the additional electrical energy generated by the solar panel, treating the predicted additional electrical energy as energy available to the battery during the methods of FIG. 6 through FIG. 8.

Other power systems also may be provided for additional fuel savings and further reliance on the battery for energy to propel the haul truck (200). For example, an electrical line (240) may be connected to the battery (226). The electrical line (240) may be a power cable, a conducting wire, etc. The electrical line (240) may be connected to an external power system (e.g., a generator, an electric power grid, other haul trucks, a solar panel farm, a windmill farm, etc.).

In an embodiment, the computer processor (234) is programmed, according to the route, to add electrical power to the external power system or to use electrical power from the external power system. For example, if the wheel motors (207, 209, 211, 213) generate more electricity than used during operation of the haul truck on a route, then the excess power may be transmitted to the external power system for use by other haul trucks, by the electrical systems of buildings, or other electrical systems. However, if more electricity is needed to power the wheel motors (207, 209, 211, 213) during operation of the haul truck (200) on a route, then the additional electricity may be supplied in whole or in part by the external supply system.

One or more embodiments shown in FIG. 2 may be varied. The motor (222) position may be altered to couple to the engine (204) instead of to the torque converter (214). Alternatively, the motor (222) may be directly coupled to the transmission (218) instead of to the engine (204) or to the torque converter (214). In this latter case, the drive shaft (216) may be connected between the motor (222) and the torque converter (214).

Still other variations are possible. For example, multiple motors could be added to increase output power. One or more motors may be connected to some or all of the wheels of the haul truck (200). The battery (226) may be replaced with hydrogen fuel cells or a trolley system, or such alternative energy sources may be added to the haul truck (200) in addition to the battery (226). For example, one or more solar cells or separately powered generators may be placed on the haul truck (200) to charge the battery (226) while the haul truck (200) is not in operation, while the engine (204) idles, or during low-speed operation.

Furthermore, one or more embodiments contemplate operating a haul truck fleet, coordinating the routes that the haul trucks of the fleet take as a whole in order to maximize the use of the electrical motors during operation of the haul truck fleet.

Thus, one or more embodiments contemplate two or more vehicles (e.g., haul trucks, such as haul truck (200), as described above). In addition, a central dispatch system is provided. The central dispatch system is a computer and a communication system for communicating with the haul truck fleet. The central dispatch system may be located at a site where the haul trucks operate, at a remote location, or on one of the haul trucks.

The central dispatch system may be programmed to assign the vehicles to two or more routes on a routing plan, within a constraint of the respective maximum charge in the battery of each of the vehicles, to maximize an overall amount of electrical charge generated by the vehicles while operating on the routes of a routing plan. The central dispatch system further may be programmed to monitor the energy statuses of the vehicles and to transmit commands to the vehicles to change, according to an overall combination of energy usage by the plurality of vehicles, operational modes of the engine, and the wheel motors of the vehicles while operating on the routes. The operational modes may include a variety of modes of operation, such as a vehicle speed, a vehicle throttle response, a brake power and response, a transmission shift point, a battery charge, an allowed engine idle time before engine shutdown, a maximum allowed vehicle load, and others.

In other words, the combined system of the fleet of vehicles is monitored for power use and power generation by the various wheel motors, as well as for fuel use, in order to maximize the amount of electrical energy used to propel the vehicles, as explained with respect to a single haul truck in FIG. 6 through FIG. 8. Thus, fuel use may be minimized, with the attendant cost savings and reduced emissions and carbon footprint.

In a variation, a power distribution system may be made available, such as a variety of power lines connected to the vehicles, or a central power station where the vehicles may go in order to receive or discharge electrical energy. The power distribution system is in communication with the central dispatch system. The power distribution system may be programmed to distribute externally generated electrical power to the vehicles and to receive electrical power generated by the vehicles.

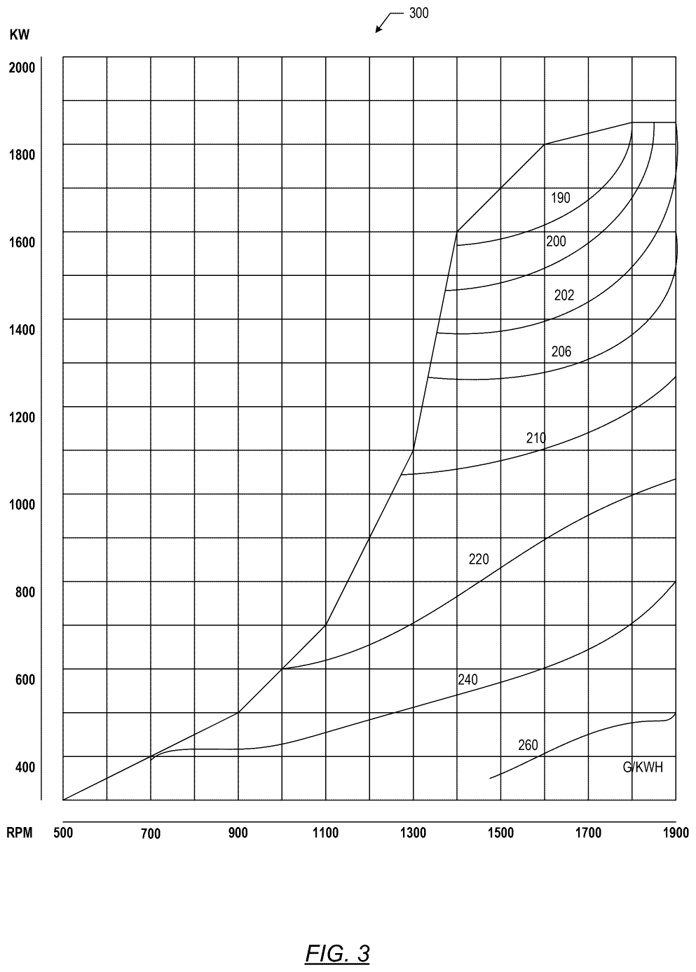

FIG. 3 shows an example of a diesel engine fuel map, in accordance with one or more embodiments. Each segment of the diesel engine fuel map (300) is the fuel used to output a certain power at a certain engine speed. The engine speed is measured in terms of the number revolutions per minute (RPM) of a drive shaft of the diesel engine. For example, 1,800 RPM at 1,800 KW uses 200 grams of fuel per kW hour.

The maximum engine power is available at 1,800 RPM. If the truck does not use full power, the engine RPM can be reduced to use less fuel. If the power required is 700 kilowatts (kW), the engine uses 260 grams per kilowatt-hour (g/kWh) of fuel at 1,800 RPM. This the fuel consumption is reduced to 220 g/kWh at 1,200 RPM.

Reducing the engine RPM means that the response from the engine is slower when full power is needed. However, the engine may ramp up to 1,800 RPM from the lower speed. A lower speed has less extra power available to use to bring the engine RPM up.

Operating at slightly less than full power provides more fuel savings. For example, operating the engine at 1,700 RPM may not offer full power, but may use only 190 g/kWh for the same power level that requires 200 g/kWh at 1,800 RPM.

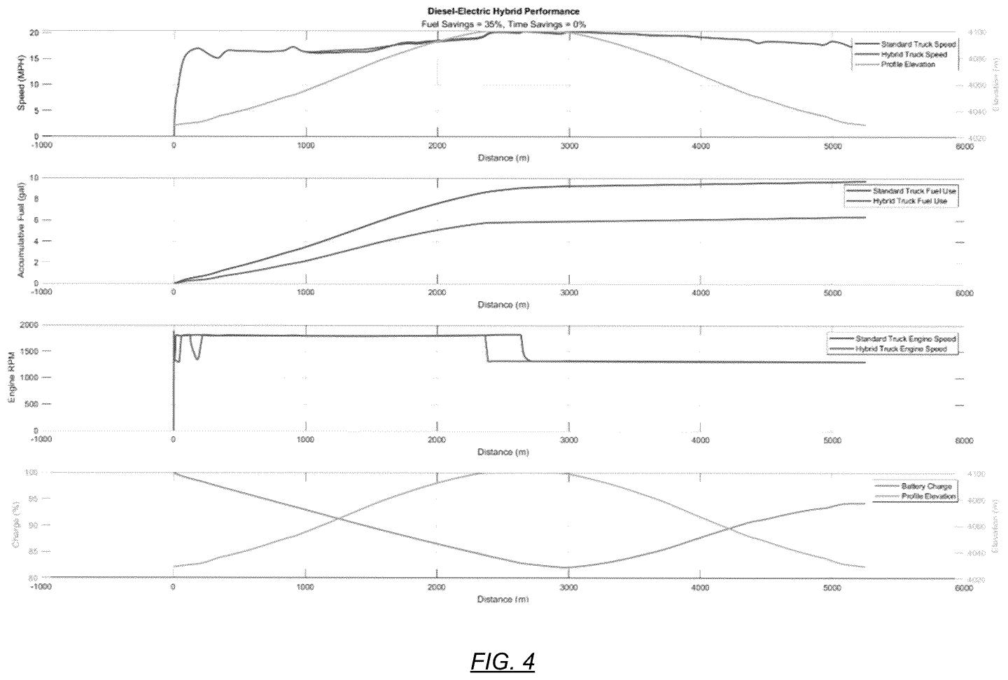

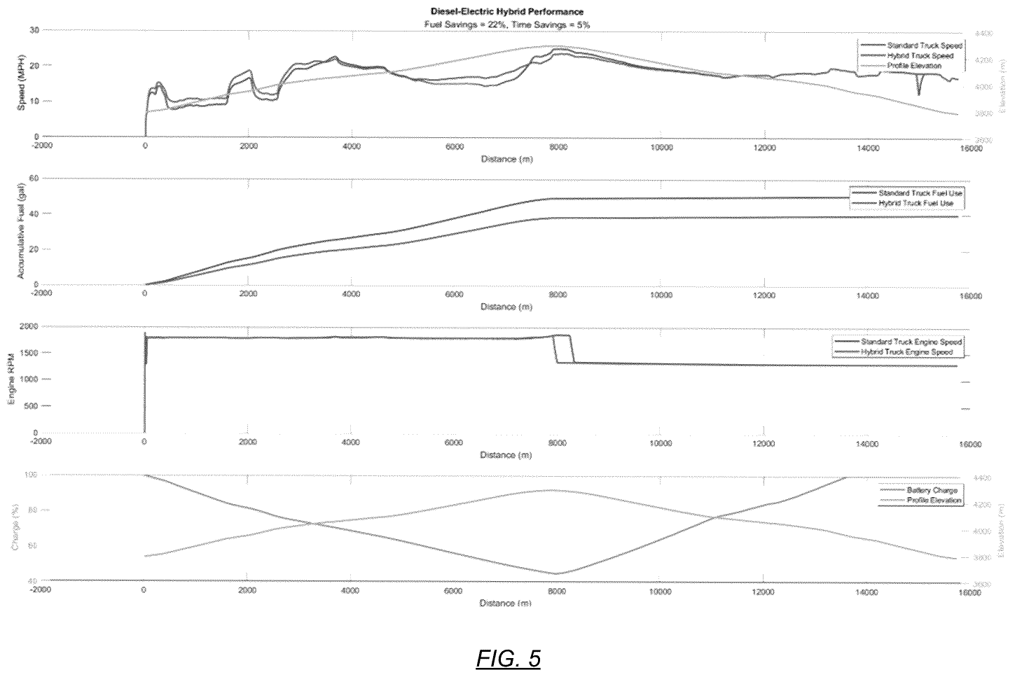

FIG. 4 shows an example of a haul truck route that results in less charge in the battery of the haul truck, in accordance with one or more embodiments. FIG. 5 shows a haul truck route that results in more charge in the battery of the haul truck, in accordance with one or more embodiments.

Haul trucks with batteries as a full or partial power source use some means of charging the battery. One charging option is to use regenerative braking when driving downhill. Regenerative braking utilizes the kinetic energy of slowing the haul truck to generate electrical power that is used to recharge the battery. Maximizing the use of regenerative braking to recharge the battery increases both the haul truck operating time and the fuel savings.

Many mine profiles contain some routes that are completed with more charge in the battery than the battery contained before operating over the route. This is due to the use of regenerative braking. Mines also predominately contain routes that are completed with less charge in the battery than the battery contained before operating over the route.

FIG. 6 shows a method for hybrid haul truck route optimization based on battery charge, in accordance with one or more embodiments. The method of FIG. 6 may be implemented for the haul truck shown in FIG. 1 or FIGS. 2, and may be used to perform the haul truck route optimization shown in FIG. 4 or FIG. 5.

Step 600 includes determining a haul truck battery level (e.g., the battery charge). The haul truck battery level may be determined using one or more electrical sensors.

Step 602 includes assigning a haul truck to a route based on the battery level. Assigning may be performed by assigning the haul truck to a more uphill route, or to a route with fewer loading times, or idle times, when the battery level determined at step 600 is relatively high (i.e., above a predetermined threshold battery level for a given route). For example, many routes may be assigned battery level thresholds, where a higher battery level threshold reflects a greater amount of electrical power that should be used to drive the truck. A lower battery level threshold reflects a lower amount of electrical energy desired to drive the truck, such as on routes that are mostly downhill or routes with long loading, or idle times. Thus, assigning also may be performed by assigning the haul truck to a more downhill route, or to a route with more loading, or idle times, when the battery level at step 600 is relatively low (i.e., below a predetermined battery level for the given route).

Step 604 includes determining a starting battery level. The starting battery level may be determined using an electrical sensor. The starting battery level is the battery charge available before the haul truck begins a route.

Step 606 includes operating the haul truck over the route assigned at step 602. The haul truck may perform normal functions (driving to a destination, carrying a load, receiving a load, etc.)

Step 608 includes determining a desired battery capacity (e.g., charge) for the route. The desired battery capacity for the route is the amount of battery capacity used that maximizes the use of wheel motors to drive the haul truck and minimizes the use of the internal combustion engine to drive the haul truck. Determining the desired battery capacity may be performed using an algorithm executable by a computer processor, or by a machine learning model (e.g., a neural network). The algorithm includes parameters that take into account the predicted electrical energy to be used by the haul truck over the course of the route, the total battery capacity available, and the predicted electrical energy to be generated by the wheel motors over the course of the route.

A machine learning model, such as a neural network, may be used to predict the battery capacity desired. For example, the neural network may be trained using training data. The training data may include information, such as the energy diesel engine fuel map of FIG. 3 and the haul truck routes shown in FIG. 4 and FIG. 5, over which a known amount of electrical energy was used and generated. The training data also may include energy use profiles and other known performance data associated with one or more haul trucks. In an embodiment, a separate neural network may be trained for each individual haul truck in order to predict the battery capacity desired for a specific haul truck with specific characteristics.

The training data may be expressed in the form of a vector data structure including features (e.g., fuel efficiency, battery charge, energy generated over a route, energy used over a route, etc.) and values for the features. The vector is then fed as input to the machine learning model being trained. The model being trained generates a prediction for a particular route. The prediction is compared to a known result for the particular route. A training software controller then predicts a loss function based on a difference between the known result and the predicted result. The training software controller then updates weights and parameters of the machine learning model in order to change the operation of the machine learning model. The process is then repeated in order to generate an updated prediction and an updated loss function. The process continues until convergence. Convergence occurs when the predicted result is within a predetermined percentage of the known result, after a certain number of training cycles, or some other predetermined stop condition.

Once convergence occurs, the model is considered trained. Once the machine learning model is trained, the machine learning model may determine the desired battery capacity level at step 608 by taking, as input, information about the route and predicting the net electrical energy generated or used during the route. The desired battery capacity at step 608 should meet or exceed the predicted net electrical energy used over the route. Alternatively, the desired battery capacity at step 608 should meet or be less than the predicted net electrical energy generated over the route.

Step 610 includes determining an ending battery level for the route. The ending battery level for the route may be determined in a manner similar to that described with respect to step 608. However, the prediction requested, or the output of the algorithm, is the predicted ending battery level of the haul truck at the end of the route.

Step 612 includes classifying the route as a battery level net gain or loss. If operating the haul truck over the route uses more electrical energy than is generated, then there is a net battery loss. If operating the haul truck over the route generates more electrical energy than is used, then there is a net battery gain.

Step 614 includes operating the haul truck according to the battery level net gain or loss. For example, if a net battery loss is expected, then the truck may be idled or supplemented with external electrical energy in order to charge the battery before beginning the route. In another example, the route may be changed to accommodate the current battery level if idling the haul truck is not desirable. In yet another example, the haul truck may be assigned to a route that is more downhill than uphill in order to add electrical energy to the battery.

The method of FIG. 6 may be repeated as desired. Accordingly, after operating a haul truck on a route, or during operation on the route, the process may return to step 600 and repeat.

FIG. 7 represents a method by which the haul truck monitors the battery charge level before running a route, during the route, and at the end of the route to determine the amount of total charge required to complete the route and the net loss or gain of charge at the end of the route. The information is then used to determine the optimal route for each operating haul truck based on its instantaneous battery charge level. “Optimal” means a mathematical function which reaches a minimum or maximum for a defined set of initial conditions.

Step 700 includes determining a truck battery level (i.e., a measurement of the charge remaining in the battery). The truck battery level may be determined as described with respect to step 600 of FIG. 6.

Step 702 includes determining if the battery level is high enough to complete a current route. Determination of the battery level may be performed as described with respect to step 608. However, the focus of step 702 is to predict whether the current battery level is sufficient to complete a current route under consideration.

If the battery level is not sufficiently high to complete a current route at step 702, then step 704 includes determining if another route is available to complete.

If another route is not available to complete at step 704 (a “no” determination), then step 706 includes using the engine to charge the battery (e.g., using an alternator connected to the battery and the engine, an external power source, a solar panel, etc.). Once the battery is sufficiently charged for the route, then step 708 includes completing the route.

Then, step 710 includes determining if the method should terminate. For example, step 710 may determine whether the truck should continue to operate. If yes at step 710, then the method terminates. Otherwise, the method returns to step 700 and continues.

Returning to step 704, if a route is available to complete for which the battery level of the truck is satisfactory (a “yes” determination), then at step 712 the truck is reassigned to a new route. Then, at step 714 the route is completed, similar to a truck's route completion at step 708. The method then proceeds to step 710, as described above.

Returning to step 702, if the battery level is high enough to complete the current route (a “yes” determination), then at step 716 a determination is made whether a net battery charge level gain occurs during the route. If not, then the route is completed at step 714 and the method proceeds as described above. However, if so (a “yes” determination at step 716), then at step 718 another determination is made whether the net gain to the battery exceeds the battery capacity. If not, then the route is completed at step 714 and the method proceeds as described above.

If so (a “yes” determination at step 718), then the truck is reassigned to a new route at step 712, and the method proceeds as described above. The new route at step 712 is selected so that electrical energy is not wasted on account of generated energy not being storable in a full battery. For example, another route may be selected in which less net gained energy is produced, or another route may be selected in which the energy in the battery is reduced.

Additional details of the methods of FIG. 6 and FIG. 7 are now presented. Haul trucks with a lower battery charge level can be moved to routes that end with a net gain in battery charge. The route change may eventually recharge the battery without requiring the haul truck to stop to charge or by using the engine to charge the battery with subsequent fuel usage. Once the battery is sufficiently charged, the haul truck can be moved to a route that ends in a net loss in battery charge.

Haul trucks with a higher battery charge level can be moved to routes that end with a net loss in battery charge. This eventually depletes the charge in the battery at which point the haul truck can be moved to a route that ends with a net gain in charge. The information can then be passed to existing haul truck dispatch systems.

As haul trucks move between the different routes based on battery level, the energy required to move to another route may be calculated to determine if more energy is used moving to the new route than is saved by operating on the new route. This information can then be passed to existing haul truck dispatch systems or communicated directly between trucks in order to determine the suitability of moving to a new route.

Stated differently, one or more embodiments provide for monitoring the battery charge level and overall power required from the battery during operation over a route. A battery management system may constantly monitor the charge and report the charge to the haul truck control system. The haul truck control system tracks the charge level over the entire operating range and can determine the total power to be used over a route and if there was a net gain or loss of charge in the battery.

The system determines when a route starts and when a route ends. The route start and end time determination may be performed using data from a payload system to determine when the haul truck is loaded and unloaded, can be provided by dispatch, or input by the driver using an interface in the truck cab. Each route with haul trucks generally begins with the haul truck being loaded, driving to the location to dump the load, then driving back to be loaded again.

The same concept may be used to save fuel on haul trucks that use power sources other than batteries. For example, if diesel or hydrogen fuel usage is tracked, then one or more embodiments can be used to move haul trucks between routes that use the least amount of fuel to minimize stoppage due to refueling. Discrepancies in fuel and battery utilization of similar haul trucks on the same route can be used to determine mechanical or engine issues on haul trucks that are using more fuel than others.

An example is now provided. A mine has a fleet of battery hybrid mechanical haul trucks. The mine has 14 routes the haul trucks operate over. Six of the routes result in a net gain of battery charge. Eight of the routes result in a net loss of battery charge.

Without the dispatch optimization, the haul trucks on the eight routes continue to run engines during idle periods to recharge the batteries. The haul trucks on the six routes have batteries with a maximum charge and do not fully use kinetic energy available during braking.

With the dispatch optimization of one or more embodiments, the haul trucks on the six routes are transferred to the eight routes once their batteries have reached full capacity. The haul trucks on the eight routes are transferred to the six routes once their batteries have reached the minimum capacity needed to complete the six routes. The optimization uses the full potential of kinetic energy available and saves the mine 15% fuel. The amount of fuel savings can be almost 100,000 gallons of fuel per year, per haul truck, in some embodiments, relative to operating solely on an internal combustion engine.

While the various steps in this flowchart are presented and described sequentially, at least some of the steps may be executed in different orders, may be combined or omitted, and at least some of the steps may be executed in parallel. Furthermore, the steps may be performed actively or passively.

More detail regarding an alternative to one or more embodiments is now presented. As described above, route optimization also may be used to minimize the fuel used in diesel haul trucks.

The diesel engines used in haul trucks may consume large amounts of fuel. The speed and load of the engine is managed by a haul truck power control system that uses various sensors, such as but not limited to engine speed sensors, engine load, and fuel data from the engine control unit along with engine performance and fuel utilization curves obtained from testing or the engine manufacturer. The engine control unit is a device responsible for operating the engine and may communicate the status of the engine and supporting systems with other parts of the truck using a predefined interface. Algorithms use this data to extract the maximum power out of the engine at any operating point. Maximum engine power increases the productivity of the haul truck, but comes at the cost of higher fuel usage.

Multiple haul trucks operate over a defined set of routes, with each route consisting of haul trucks being loaded by a single piece of equipment and the haul trucks traveling to another location to dump the load. In many instances, the single piece of equipment loading the haul trucks is the limiting factor on the speed of the operation and the haul trucks must wait in a queue to be loaded.

Multiple diesel engine control modes include but are not limited to being used on haul trucks to change the management of the engine on the fly depending on the quantity of haul trucks operating on a route, the speed of the slowest haul truck, weather conditions, rolling resistance of the road, delay at the dumping area, the delay at the loading equipment, current price of fuel, or current price of the material being mined. If a delay or fuel price is the limiting factor for the speed of the operation, the haul truck diesel engine control mode can be changed to optimize fuel savings rather than to maximize power (i.e., to reduce power and operate the truck more slowly in order to give the loading equipment more time to load). Such optimization may reduce the ultimate performance of the haul truck for the benefit of fuel savings when ultimate performance is not needed. Furthermore, if road conditions are poor resulting in reduced traction, the engine control mode can be changed to optimize fuel savings as ultimate performance is not practical. If the loading equipment is not the limiting factor for the speed of the operation, the road conditions improve, or the material being mined has a price that provides an advantage for a higher production rate, the diesel engine control mode can be changed to optimize ultimate performance.

A higher production rate may be defined as operating the truck at a higher speed to increase the amount of material the truck moves in a period of time compared to a truck without the higher speed. This higher speed can be obtained moving uphill when the truck speed is limited by available engine power. Increasing the total power output of the truck using the additional power in a battery or similar storage device allows the truck to increase speed during these instances.

The operating statistics for each haul truck, such as but not limited to specific route, location, speed, idle time, fuel usage, fuel level, and route time, are logged and managed locally on the truck controller and by a central dispatch system. The central dispatch system or truck controller uses algorithms to determine the status of the haul trucks on each route. If the dispatch system or truck controller determines that the route completion time is limited by the loading equipment, slower haul trucks, or conditions, the dispatch system or truck controller can either automatically change the engine control mode on the haul truck or alert the driver to change the control mode using a selection device in the operator's cab. The driver can also change the mode independently based on current conditions or if the fuel level on the haul truck is below a certain threshold to extend the time before fueling. The new mode is then transmitted to the dispatch system or locally to other trucks for use in determining the modes for the other haul trucks on the route.

Moving from performance engine control mode to fuel saving engine control mode changes the algorithms in the haul truck power control system based on the specific details of the engine used in the haul truck and adjusts the total power output by the drive system. The data includes, but is not limited to, an engine fuel map that provides performance curves for optimum load and optimum fuel usage. The engine fuel may be defined by a curve (see FIG. 3) that is used to adjust the engine speed based on the instantaneous power required from the engine calculated using various sensors and systems on the haul truck.

An example of using the engine fuel curve is now provided. Each segment of the map is the fuel required to output a certain power at a certain engine speed (RPM). For example, 1,800 RPM at 1,800 kW requires 200 grams of fuel per kW hour. Max engine power is available at 1,800 RPM. If the truck does not require full power, the engine RPM can be reduced to use less fuel. If the power required is 700 KW, the engine requires 260 g/kWh of fuel at 1,800 RPM. This is reduced to 220 g/kWh at 1,200 RPM. Reducing the engine RPM means that the response from the engine is slower when full power is needed. It has to increase to 1,800 RPM from the lower speed. A lower speed has less extra power available to use to bring the engine RPM up. Operating at slightly less than full power provides more fuel savings. For example, 1,700 RPM does not offer full power, but requires 190 g/kWh for the same power level that requires 200 g/kWh at 1,800 RPM.

The performance and fuel saving modes can also impact other portions of the haul truck beyond engine control. The system can change operational parameters of the haul truck, such as but not limited to, maximum allowed haul truck speed limits, a maximum allowed vehicle load carried by a haul truck, throttle response, brake power and response, transmission shift points, battery charging details, and allowed idle time before engine shutdown in the event an idle management system is installed. An idle management system is defined as a series of devices that allow the engine to be shut down while the truck motion is stopped and started again when the truck needs to move.

Haul truck power control systems optionally may directly communicate peer to peer, without a central dispatch system, to determine the engine control mode best suited for conditions. Peer to peer communication may use a wireless communication system specific to the trucks or a system shared by the rest of the operating site. Trucks that pass each other on a route can directly provide the details, such as but not limited to route conditions (based on operating speed, usage of traction control, and braking), power required, and engine control mode that was used on the section of the route that one truck just completed and the other truck is about to start. Machine learning (artificial intelligence) can be used to modify both the engine fuel map and the performance mode on the fly without any operator interaction, using the information obtained during operation, passed from dispatch, and directly communicated peer to peer.

The statistics for mode selection and route specific times can be further used to detect haul trucks that may have future mechanical or electrical problems. If a certain model haul truck requires performance mode to maintain the same route times as other similar model haul trucks in fuel saving mode, the sustained use of performance mode could be a sign of pending maintenance problems. Increased fuel usage of a truck over a route compared to similar model trucks or historic data of that truck can also be a sign of pending maintenance problems. Thereafter, the haul truck may be inspected for any desired maintenance and, if warranted, such maintenance be performed before failure of one or more systems of the haul truck.

Long term, diesel engines in haul trucks may be replaced with hydrogen fuel cell, battery hybrid, or full battery powered systems. Nevertheless, one or more embodiments can be used to adjust the amount of power pulled from batteries or fuel cells for either higher performance or charge/fuel management. Accordingly, one or more embodiments may be expanded to reduce the power pulled from the battery or fuel cell if the charge or fuel level drops below a certain threshold. The power management may allow the haul truck to operate for a longer period of time at reduced performance before stopping to charge or refuel.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

FIG. 8 is a method of operating a vehicle. The method of FIG. 8 is a variation of the method of FIG. 6 and the method of FIG. 7. The method of FIG. 8 may be performed using the haul truck of FIG. 1 or FIG. 2, or may be performed using another hybrid vehicle that derives propulsive power from a combination of an engine, a battery, and a motor that is connected to the drive system of the vehicle.

Step 800 includes measuring an initial charge in a battery of a vehicle including a wheel and a wheel motor connected to the wheel and to the battery.

Measuring the initial charge may be performed as explained in step 600 of FIG. 6 (e.g., using a sensor, such as a voltmeter or other electrical sensor to measure the charge in the battery).

Step 802 includes predicting, by a computer processor, a number of expected increases in a charge of the battery, a number of expected decreases in the charge of the battery, or a combination thereof, while operating the vehicle over a number of routes in a routing plan. The prediction may be performed according to the techniques described with respect to step 608 of FIG. 6. For example, an algorithm or a trained machine learning model may predict the increases, decreases, and net change in the electrical charge of the battery over the course of a route. The same prediction may be performed over multiple routes available in a routing plan. Thus, the net predicted energy change in the battery may be predicted for the routes in the routing plan.

Step 804 includes selecting a selected route from among the number of routes according to at least one of: the initial charge, a maximum net increase in the charge on the selected route relative to other routes on the number of routes, a minimum decrease in the charge on the selected route relative to the other routes, or maintaining the charge on the selected route relative to the other routes. Selecting the route may be performed as described with respect to step 614 of FIG. 6 or as described with respect to FIG. 7.

Step 806 includes operating the vehicle on the selected route before operating the vehicle on the other routes. Step 806 may be performed as described with respect to step 614 of FIG. 6 or steps 708 or 714 of FIG. 7.

The method of FIG. 8 may be varied. The method of FIG. 8 may include more or fewer steps, or the steps may be varied. For example, FIG. 8 may include adjusting an operational parameter of the vehicle while operating the vehicle on the selected route to further increase the charge or to limit a decrease in the charge. In other words, the performance of the vehicle with respect to electrical generation and use may be monitored, and the operational parameter of the vehicle adjusted accordingly to refine the optimum use or generation of electrical energy along the specific route taken by the vehicle. The operational parameter may include the speed of the vehicle, selection of a different route, modification of how a route is traveled (e.g., to zig zag along steeper portions of the route), the time spent loading or idling the vehicle, etc.

One or more embodiments may be implemented on a computing system specifically designed to achieve an improved technological result. The computing system may be located onboard a haul truck, or may be a remote server, or other remote computing system that communicates with and provides automated instructions to a haul truck. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 9A, the computing system (900) may include one or more computer processor(s) (902), non-persistent storage device(s) (904), persistent storage device(s) (906), a communication interface (908) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) (902) may be one or more cores, or micro-cores, of a processor. The computer processor(s) (902) includes one or more processors. The computer processor(s) (902) may include a central processing unit (CPU), a graphics processing unit (GPU), a tensor processing unit (TPU), combinations thereof, etc.

The input device(s) (910) may include a touchscreen, keyboard, mouse, microphone, touchpad, electronic pen, or any other type of input device. The input device(s) (910) may receive inputs from a user that are responsive to data and messages presented by the output device(s) (912). The inputs may include text input, audio input, video input, etc., which may be processed and transmitted by the computing system (900) in accordance with one or more embodiments. The communication interface (908) may include an integrated circuit for connecting the computing system (900) to a network (not shown) (e.g., a local area network (LAN), a wide area network (WAN), such as the Internet, mobile network, or any other type of network) or to another device, such as another computing device, and combinations thereof.

Further, the output device(s) (912) may include a display device, a printer, external storage, or any other output device. One or more of the output device(s) (912) may be the same or different from the input device(s) (910). The input device(s) (910) and output device(s) (912) may be locally or remotely connected to the computer processor(s) (902). Many different types of computing systems exist, and the aforementioned input device(s) (910) and output device(s) (912) may take other forms. The output device(s) (912) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (902), is configured to perform one or more embodiments, which may include transmitting, receiving, presenting, and displaying data and messages described in the other figures of the disclosure.

The computing system (900) in FIG. 9A may be connected to, or be a part of, a network. For example, as shown in FIG. 9B, the network (920) may include multiple nodes (e.g., node X (922) and node Y (924), as well as extant intervening nodes between node X (922) and node Y (924)). Each node may correspond to a computing system, such as the computing system shown in FIG. 9A, or a group of nodes combined may correspond to the computing system shown in FIG. 9A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922) and node Y (924)) in the network (920) may be configured to provide services for a client device (926). The services may include receiving requests and transmitting responses to the client device (926). For example, the nodes may be part of a cloud computing system. The client device (926) may be a computing system, such as the computing system shown in FIG. 9A. Further, the client device (926) may include or perform all or a portion of one or more embodiments.

The computing system of FIG. 9A may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first predetermined range of angles for one embodiment, but also may be “about congruent” if the values of the two angles are within a second predetermined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

In addition, the term “directly connected to” means that component A and component B are connected immediately adjacent to each other. For example, component A and component B may share a common point of contact in at least one area of both components. However, the common point of contact may be a connector (e.g., a bolt, a screw, etc.), in which case it is possible that component A is “directly connected to” component B without a direct contact between the surfaces of component A and component B. However, in any case, if component A and component B are “directly connected to” each other, then no intervening parts, other than possibly a connector, exist between component A and component B.

With regard to computing systems and networks, the term “connected to” also contemplates multiple meanings. A computing or network connection may be direct or indirect (e.g., through another component or network). A computing or network connection may be wired or wireless. A computing or network connection may be a temporary, permanent, or a semi-permanent communication channel between two entities.

The figures show diagrams of embodiments that are in accordance with the disclosure. The embodiments of the figures may be combined and may include or be included within the features and embodiments described in the other figures of the application. The features and elements of the figures are, individually and as a combination, improvements to the technology of hybrid haul truck route optimization based on battery charge of the haul truck's battery. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description. Further, other embodiments not explicitly described above can be devised which do not depart from the scope of the one or more embodiments as disclosed herein. Accordingly, the scope of the one or more embodiments should be limited by the attached claims.

What is claimed is:

1. A vehicle comprising:
a chassis;
an engine connected to the chassis;
an alternator connected to the engine;
a drive system connected to the alternator;
a plurality of wheel motors connected to the drive system;
a plurality of wheels connected to the plurality of wheel motors;
a battery connected to the plurality of wheel motors and to the alternator; and
a computer processor connected via a plurality of sensors to the engine, the alternator, the drive system, the plurality of wheel motors, the plurality of wheels, the battery, and to a data repository storing a routing plan for a plurality of vehicles including the vehicle, wherein the computer processor is programmed to assign, according to a current charge in the battery, the vehicle to a route on the routing plan.

2. The vehicle of claim 1, wherein the computer processor is further configured to assign the vehicle to the route according to other routes of the plurality of vehicles.

3. The vehicle of claim 1, wherein the route is selected to use more charge in the battery when operating the vehicle on the route than to gain charge in the battery when operating the vehicle on the route.

4. The vehicle of claim 1, wherein the route is selected to gain more charge in the battery when operating the vehicle on the route than to use charge in the battery when operating the vehicle on the route.

5. The vehicle of claim 1, further comprising:
a control system connected to the battery, the engine, and the plurality of wheel motors, wherein the control system is configured to modify operation of each of the engine, the plurality of wheel motors, and the battery according to the route.

6. The vehicle of claim 5, wherein the computer processor is further in electronic communication with the control system, and the computer processor is programmed to control operation of at least one of the battery, the engine, the plurality of wheel motors via the control system.

7. The vehicle of claim 5, further comprising:
a control system connected to the control system and configured to control distribution of electrical power to the plurality of wheel motors and the battery,
wherein the control system further controls a speed of operation of the vehicle on the route to either minimize a first amount of energy drained from the battery over a course of the route or to maximize a second amount of energy added to the battery over the course the route.

8. The vehicle of claim 7, wherein:
the computer processor is further programmed to estimate a ratio of fuel savings by the vehicle relative to a performance increase by the vehicle, and
the computer processor is programmed to order the control system to modify operation of the vehicle on the route to increase the fuel savings or improve the performance increase based on the ratio.

9. The vehicle of claim 8, wherein the computer processor is further programmed to determine a health of the vehicle based on an unplanned change to the ratio while the vehicle operates on the route.

10. The vehicle of claim 1, wherein the computer processor is further configured, after the vehicle completes the route, to reassign the vehicle to a second route in the plurality of routes to maximize an amount of energy generated by the plurality of wheel motors during operation of the plurality of wheel motors over a combination of the route and the second route.

11. The vehicle of claim 1, further comprising:
a solar panel connected to the chassis and in electrical communication with the battery.

12. The vehicle of claim 11, wherein the computer processor is further programmed to assign the vehicle to the route according to a predicted amount of electrical energy generated by the solar panel.

13. The vehicle of claim 1, further comprising:
an electrical line connected to the battery and connectable to an external power system,
wherein the computer processor is further programmed, according to the route, to add electrical power to the external power system or to use electrical power from the external power system.

14. The vehicle of claim 1, wherein the computer processor is further programmed, prior to operating the vehicle on the route, to predict a total change in charge to the battery over a course of operating the vehicle on the route.

15. A system comprising:
a plurality of vehicles, wherein each of the plurality of vehicles comprises:
a chassis;
an engine connected to the chassis;
an alternator connected to the engine;
a drive system connected to the alternator;
a plurality of wheel motors connected to the drive system;
a plurality of wheels connected to the plurality of wheel motors;
a battery connected to the plurality of wheel motors and to the alternator, the battery having a respective maximum charge; and
a computer processor connected via a plurality of sensors to the engine, the alternator, the drive system, the plurality of wheel motors, the plurality of wheels, and the battery; and
a central dispatch system programmed to assign the plurality of vehicles to a plurality of routes on a routing plan, within a constraint of the respective maximum charge in the battery of each of the plurality of vehicles, to maximize an overall amount of electrical charge generated by the plurality of vehicles while operating the plurality of vehicles on the plurality of routes.

16. The system of claim 15, wherein the central dispatch system is further programmed to monitor a plurality of energy statuses of the plurality of vehicles and to transmit commands to the plurality of vehicles to change, according to an overall combination of energy usage by the plurality of vehicles, operational modes of the engine and the plurality of wheel motors of the plurality of vehicles while operating on the plurality of routes.

17. The system of claim 16, wherein the operational modes are selected from the group consisting of: a vehicle speed, a vehicle throttle response, a brake power and response, a transmission shift point, a battery charge, an allowed engine idle time before engine shutdown, and a maximum allowed vehicle load.

18. The system of claim 15, further comprising:
a power distribution system in communication with the central dispatch system, wherein the power distribution system is programmed to distribute externally generated electrical power to the plurality of vehicles and to receive electrical power generated by the plurality of vehicles.

19. A method comprising:
measuring an initial charge in a battery of a vehicle comprising a wheel and a wheel motor connected to the wheel and to the battery;
predicting, by a computer processor, a plurality of expected increases in a charge of the battery, a plurality of expected decreases in the charge of the battery, or a combination thereof, while operating the vehicle over a plurality of routes in a routing plan;
selecting a selected route from among the plurality of routes according to at least one of: the initial charge, a maximum net increase in the charge on the selected route relative to other routes on the plurality of routes, a minimum decrease in the charge on the selected route relative to the other routes, or maintaining the charge on the selected route relative to the other routes; and
operating the vehicle on the selected route before operating the vehicle on the other routes.

20. The method of claim 19, further comprising:
adjusting an operational parameter of the vehicle while operating the vehicle on the selected route to further increase the charge or to limit a decrease in the charge.
